(19) United States
(12) Patent Application Publication
(10) Pub. No.: US 2011/0057854 A1
(43) Pub. Date: Mar. 10, 2011

(54) Identification Tag for Identifying Objects with a Metal Surface

(75) Inventors: Gerd Elbinger, Furth (DE); Klaus Müller, Pommersfelden (DE); Gerhard Rötter, Veitsbronn (DE)

(73) Assignee: Siemens AG, München (DE)

(21) Appl. No.: 12/867,347

(22) PCT Filed: Feb. 12, 2008
(86) PCT No.: PCT/EP2008/001062

§ 371 Date: Nov. 19, 2010

(51) Int. Cl. H01Q 1/48

(52) U.S. Cl. 343/846

(57) ABSTRACT

The invention relates to a device for identifying an object (1) having a surface that is at least partially metal and which comprises an identification tag (2) and an antenna (3) that is fixed at least indirectly to the metal surface. According to the invention, a surface electric contact or a tight capacitive coupling is arranged between the metal surface and the antenna (3).

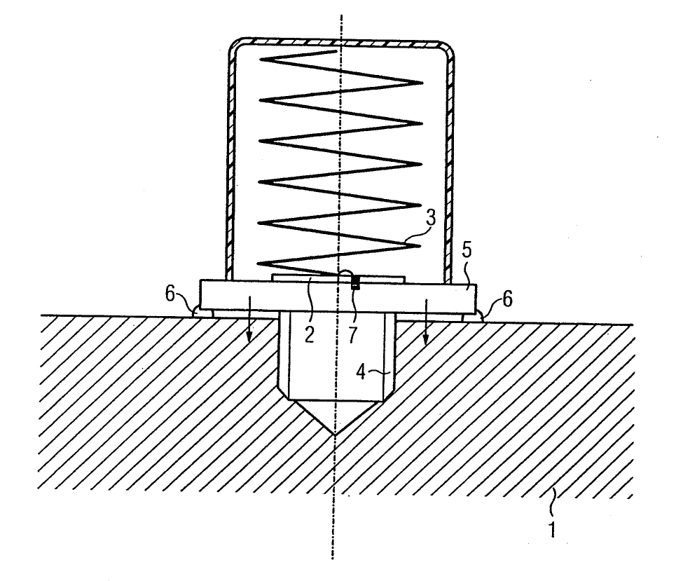

### CROSS-REFERENCE TO RELATED APPLICATIONS

This is a U.S. national stage of International Application No. PCT/EP2008/001062, filed on 12 Feb. 2008.

### BACKGROUND OF THE INVENTION

1. Field of the Invention

The invention relates to identity verification and, more particularly, to a device for identification of an object having an at least partially metallic surface, an identification mark and an antenna which is at least indirectly mounted on the metallic surface.

2. Description of the Related Art

Devices for identifying objects are known. For example, it is known for a dipole antenna to be fitted to devices such as these at a certain distance, with the aid of a spacer on the metal surface. Here, the physical form is relatively large, and the resultant directional effect of the antenna field is orthogonal to the polarization axis of the antenna.

It is also known for inverted F-antennas to be used, which have a flat profile and in which the spacer can be omitted. In some applications, these inverted F-antennas also have a poor directional effect, since the identification maximum is directed orthogonally to the identification object.

In automobile production and machine construction, Radio Frequency Identification (RFID) technology is increasingly required. Generally, in the UHF or microwave frequency band, for identification of tools and workpieces, consisting entirely or mostly of metal. Here, the identification mark, which may comprise a tag, transponder or mobile data memory, should be fitted directly to metal parts or metal surfaces of the object to be identified.

### SUMMARY OF THE INVENTION

It is therefore an object of the invention to provide a device which allows an application-specific directional effect of an antenna field.

This and other objects and advantages are achieved by a device having an at least partially metallic surface, where the device comprises an identification mark and an antenna which is at least indirectly mounted on the at least partially metallic surface.

In accordance with the invention, a flat electrical contact or close capacitive coupling is produced between the metallic surface and the antenna by a contact pressure on the metallic surface. In addition, the antenna is a helical monopole or a monopole comprising a rod, where the polarization axis of the antenna is directed away from the metallic surface or directed at right angles to the metallic surface.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention will be explained in more detail in the following text with reference to the drawing, in which:

The FIGURE is an illustration of a schematic block diagram of the device in accordance with an embodiment of the invention.

### DESCRIPTION OF THE PREFERRED EMBODIMENTS

The drawing illustrates a device for identification of an object 1 with an at least partially metallic surface. The object 1 may be a metal body, such as a workpiece, a tool, a metal container or automobile bodywork. The device has an identification mark 2 which, in a known manner, may comprise, for example, a tag, a transponder or mobile data memory. Furthermore, the device has an antenna 3 which is mounted at least indirectly on the metallic surface. A large-area electrical contact, or close capacitive coupling, exists between the metallic surface and the antenna 3. Here, the metallic surface of the object to be identified acts as a counterweight or reflector for the antenna 3.

The electrical contact or the close capacitive coupling is produced by a high contact pressure of the device on the metallic surface. This is achieved by pushing the device against the object 1 with a force produced by a screw thread 4.

The antenna 3 is advantageously a helical monopole or a monopole comprising a rod. The polarization axis of the antenna may be at right angles to the metallic surface, or may be directed considerably away from the metallic surface to achieve a desired directional effect of the antenna field.

The identification mark 2 is fitted to an electrically conductive mount 5, which is electrically connected by contact points to the metallic surface. In the present exemplary embodiment, the contact points 6 comprise a contact ring. An electrical connection 7 exists between the antenna 3 and the conductive mount 5. In the device, the force for the contact pressure is exerted on the metallic surface through the electrically conductive mount 5.

The device in accordance with the invention has the particular advantage that the geometry of the antenna field can be influenced or shaped by fitting and aligning the helical antenna 3, or the antenna 3 comprising the rod, on the metallic surface. For example, it is possible to form an annular field concentric around the axis, thus allowing data transmission in the full central circumference orthogonally to the polarization axis of the antenna 3. This results in major advantages when, during further processing steps, the object is partially refitted, as a result of which vertical reading or identification is no longer possible. It is also possible to identify and to read the identification mark 2 from mutually perpendicular directions.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A device for identification of an object having an at least partially metallic surface, comprising:
an identification mark; and
an antenna at least indirectly mounted on the at least partially metallic surface, the antenna being one of a helical monopole and a monopole and comprising a rod; and
a flat electrical contact or close capacitive coupling produced between the metallic surface and the antenna by a contact pressure on the metallic surface;
wherein a polarization axis of the antenna is one of directed away from the at least partially metallic surface and disposed at right angles to the at least partially metallic surface.

14. The device as claimed in claim 13, wherein the identification mark is applied to an electrically conductive mount which is electrically connected through contact points to the at least partially metallic surface.

15. The device as claimed in claim 13, wherein the contact points comprise a contact ring.

16. The device as claimed in claim 13, wherein the contact pressure is applied by a screw thread.

17. The device as claimed in claim 13, wherein an electrical connection exists between the conductive mount and a network formed from the antenna and the identification mark.

18. The device as claimed in claim 13, wherein the identification mark comprises one of a Radio Frequency Identification (RFID) tag, a transponder and a mobile data memory.

19. The device as claimed in claim 13, wherein the object is a tool or a workpiece mount.

20. The device as claimed in claim 13, wherein the object is a metal container.

21. The device as claimed in claim 20, wherein the metal container is a metal barrel.
